(19) United States
(12) Patent Application Publication
(10) Pub. No.: US 2024/0154500 A1
(43) Pub. Date: May 9, 2024

(54) MOTOR AND MOTOR COOLING SYSTEM

(71) Applicant: KYUNGPOOK NATIONAL UNIVERSITY INDUSTRY-ACADEMIC COOPRATION FOUNDATION, Daegu (KR)

(72) Inventor: Il Seouk Park, Daegu (KR)

(73) Assignee: KYUNGPOOK NATIONAL UNIVERSITY INDUSTRY-ACADEMIC COOPRATION, Daegu (KR)

(21) Appl. No.: 18/280,224

(22) PCT Filed: Feb. 28, 2022
(86) PCT No.: PCT/KR2022/002852

§ 371 Date: Sep. 2, 2023

(30) Foreign Application Priority Data
Mar. 2, 2021 (KR) 10-2021-0027356

(51) Int. Cl. H02K 9/22; H02K 9/20; H02K 9/26

(52) U.S. Cl. CPC H02K 9/225; H02K 9/20; H02K 9/26

(57) ABSTRACT

A motor includes a stator in which a coil is wound and which forms a magnetic field by a current flowing through the coil; a rotor which is surrounded by the stator and is rotated by the magnetic field; and a heat pipe which is inserted into the rotor, wherein the heat pipe is formed to protrude at one end thereof out of the rotor, and cools the rotor by causing heat exchange between the rotor and the outside through one end thereof. In addition, a motor cooling system includes a motor in which a cooling fluid circulating therethrough is accommodated; a filter which filters the cooling fluid having passed through the motor; and a cooler which cools the cooling fluid having absorbed heat from the motor, wherein the cooling fluid cooled by the cooler is introduced into and cools the motor again.

### TECHNICAL FIELD

A motor and a motor cooling system are disclosed.

Specifically, disclosed are a motor and a motor cooling system that may efficiently cool heat generated when the motor operates by including a heat pipe that is inserted into a rotator of the motor and accommodates a cooling fluid.

### BACKGROUND ART

Generally, a motor includes a stator and a rotor. Windings are wound on the stator, and when current flows through the wound windings, a magnetic field may be formed. When a magnetic field is generated in this way, the rotor rotates to generate power for the motor. At this time, heat is generated inside the motor due to electrical loss caused when the current flows through the windings and mechanical loss caused when the motor rotates. The motor has issues such as a reduction of the life of a bearing or insulation breakdown due to deterioration of an internal insulating component if such heat is not cooled appropriately. These issues may eventually affect the performance of the motor. Therefore, in order to improve the performance of the motor, it is necessary to efficiently cool the heat generated in the motor.

The above description is information the inventor(s) acquired during the course of conceiving the present disclosure, or already possessed at the time, and is not necessarily art publicly known before the present application was filed.

Prior Art Document: Japanese Patent Registration No. 5267750

### DISCLOSURE OF THE INVENTION

### Technical Goals

An embodiment provides a motor and a motor cooling system that may effectively cool the heat generated in the motor through a heat pipe having high thermal conductivity, installed in a rotor of the motor, thereby ultimately preventing degradation of the performance of the motor.

The technical tasks obtainable from the present disclosure are non-limited by the above-mentioned technical tasks. And, other unmentioned technical tasks can be clearly understood from the following description by those having ordinary skill in the technical field to which the present disclosure pertains.

### Technical Solutions

According to an embodiment to achieve the above goals, a motor includes a stator in which a coil is wound and which forms a magnetic field by a current flowing through the coil; a rotor which is surrounded by the stator and is rotated by the magnetic field; and a heat pipe which is inserted into the rotor, wherein the heat pipe may be formed to protrude at one end thereof out of the rotor, and cool the rotor by causing heat exchange between the rotor and the outside through the one end.

According to an aspect, the heat pipe may include an insertion portion which contacts the inside of the rotor; and a protrusion which extends from the insertion portion and protrudes out of the rotor, wherein the insertion portion may absorb heat generated in the rotor, and the protrusion may transfer the heat absorbed by the insertion portion to the outside to cool the rotor.

According to an aspect, the heat pipe may include an accommodating portion which forms a space for accommodating a cooling fluid therein, and the cooling fluid may cause heat transfer between a portion of the heat pipe inserted into the rotor and the one end of the heat pipe protruding to the outside while moving in the accommodating portion.

According to an aspect, the accommodating portion may have a tapered shape whose diameter increases as it extends from the rotor to the outside, and the cooling fluid may be capable of circulating in a longitudinal direction of the rotor when the rotor rotates.

According to an aspect, the rotor may include a shaft rotatably disposed at a center thereof, and the heat pipe may be provided as a single cylinder and inserted into a center of the shaft.

According to an aspect, the rotor may include a shaft rotatably disposed at a center thereof, and the heat pipe may be provided as a hollow cylinder and inserted into the rotor in a form surrounding an outer surface of the shaft.

According to an aspect, the heat pipe may be provided as a plurality of cylinders, and the heat pipes may be spaced apart from each other in a circumferential direction of the rotor.

According to an embodiment to achieve the above goals, a motor cooling system includes a motor in which a cooling fluid circulating therethrough is accommodated; a filter which filters the cooling fluid having passed through the motor; and a cooler which cools the cooling fluid having absorbed heat from the motor, wherein the cooling fluid cooled by the cooler may be introduced into the motor again to cool the motor.

According to an aspect, the motor may include a stator in which a coil is wound and which forms a magnetic field by a current flowing through the coil; a rotor which is surrounded by the stator and is rotated by the magnetic field; and a heat pipe which is inserted into the rotor, wherein the cooling fluid may absorb heat generated in the rotor while passing through the heat pipe.

According to an aspect, the motor cooling system may further include a pump which moves the cooling fluid from the filter to the cooler or from the cooler to the motor.

### Effects

A motor and a motor cooling system according to an embodiment may achieve an effect of effectively cooling the heat generated in the motor through a heat pipe having high thermal conductivity, installed in a rotor of the motor, thereby ultimately preventing degradation of the performance of the motor.

The effects of the motor and the motor cooling system according to an embodiment are not limited to the above-mentioned effects, and other unmentioned effects can be clearly understood from the following description by one of ordinary skill in the art.

### BRIEF DESCRIPTION OF DRAWINGS

FIG. 1 is a perspective view of a motor according to a first embodiment.

FIG. 2 is a perspective view of a motor according to a second embodiment.

FIG. 3 is a cross-sectional view illustrating a heat pipe of the motor according to the second embodiment.

FIG. 4 is a perspective view of a motor according to a third embodiment.

FIG. 5 is a cross-sectional view of the motor according to the third embodiment.

FIG. 6 is a schematic diagram of a motor cooling system according to an embodiment.

The accompanying drawings illustrate preferred embodiments of the present disclosure, and are provided together with the detailed description for better understanding of the technical idea of the present disclosure. Therefore, the present disclosure should not be construed as being limited to the embodiments set forth in the drawings.

### BEST MODE FOR CARRYING OUT THE INVENTION

Hereinafter, embodiments will be described in detail with reference to the illustrative drawings. Regarding the reference numerals assigned to the components in the drawings, it should be noted that the same components will be designated by the same reference numerals, wherever possible, even though they are shown in different drawings. Further, in the following description of the present embodiments, a detailed description of publicly known configurations or functions incorporated herein will be omitted when it is determined that the detailed description obscures the subject matters of the present embodiments.

In addition, the terms first, second, A, B, (a), and (b) may be used to describe constituent elements of the embodiments. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the embodiments described above and an element having a common function. Unless otherwise mentioned, the descriptions of the examples may be applicable to the following examples and thus, duplicated descriptions will be omitted for conciseness.

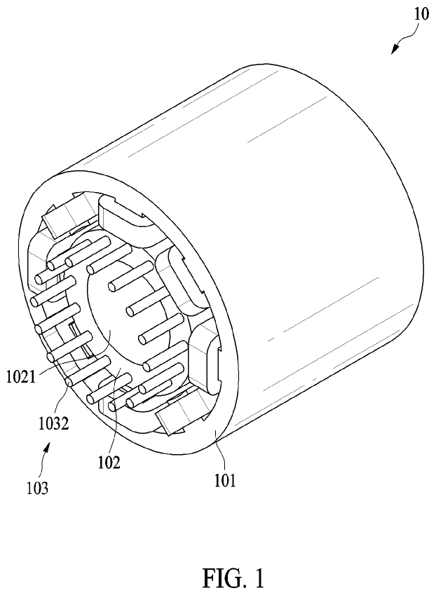

FIG. 1 is a perspective view of a motor 10 according to a first embodiment.

Referring to FIG. 1, the motor 10 according to the first embodiment may include a stator 101, a rotor 102, and a heat pipe 103.

Specifically, the stator 101 may have a coil wound therein and form a magnetic field by a current flowing through the coil.

The rotor 102 may be surrounded by the stator 101 and rotated by the magnetic field generated in the coil of the stator 101.

The rotor 102 may include a shaft 1021. The shaft 1021 may be disposed at the center of the rotor 102 and may be a rotation axis of the rotor 102.

The heat pipe 103 may be inserted into the rotor 102.

The heat pipe 103 may be formed to protrude at one end thereof out of the rotor 102. Heat exchange may occur between the rotor 102 and the outside through the one end of the heat pipe 103. Accordingly, the rotor 102 may be cooled.

The heat pipe 103 may be formed in a cylindrical shape. These cylindrical heat pipes 103 may be provided in plurality. The heat pipes 103 may be spaced apart from each other in the circumferential direction of the rotor 102. At this time, the heat pipes 103 may not contact the shaft 1021 of the rotor 102.

In addition, each heat pipe 103 may include an insertion portion (not shown) and a protrusion 1032.

Specifically, the insertion portion may be inserted into the rotor 102 and directly contact the rotor 102. This insertion portion may absorb the heat generated in the rotor 102.

The protrusion 1032 may extend from the insertion portion and protrude out of the rotor 102. That is, the protrusion 1032 is a portion that does not contact the rotor 102 and contacts the outside. This protrusion 1032 may dissipate the heat from the heat pipe 103 to the outside. That is, the protrusion 1032 may transfer the heat from the rotor 102, absorbed by the insertion portion, to the outside.

The heat pipe 103 including the insertion portion and the protrusion 1032 described above may cause heat exchange between the rotor 102 and the outside, thereby improving the cooling efficiency of the motor 10 according to the first embodiment.

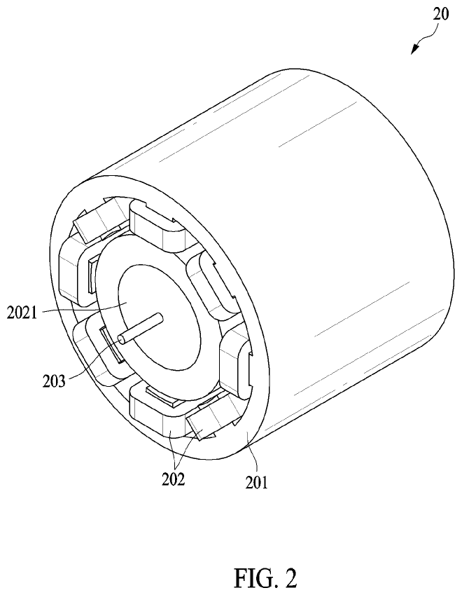

FIG. 2 is a perspective view of a motor 20 according to a second embodiment.

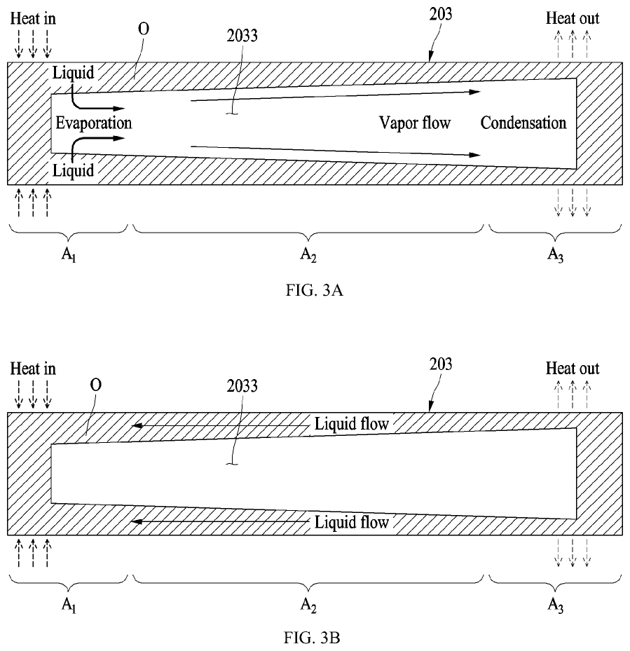

FIG. 3 is a cross-sectional view illustrating a heat pipe 203 of the motor 20 according to the second embodiment.

Referring to FIG. 2, the motor 20 according to the second embodiment may include a stator 201, a rotor 202, and the heat pipe 203.

Specifically, the stator 201 may have a coil wound therein and form a magnetic field by a current flowing through the coil.

The rotor 202 may be surrounded by the stator 201 and rotated by the magnetic field generated in the coil of the stator 201.

The rotor 202 may include a shaft 2021. The shaft 2021 may be disposed at the center of the rotor 202 and may be a rotation axis of the rotor 202.

The heat pipe 203 may be inserted into the rotor 202.

The heat pipe 203 may be formed to protrude at one end thereof out of the rotor 202. Heat exchange may occur between the rotor 202 and the outside through the one end of the heat pipe 203. Accordingly, the rotor 202 may be cooled.

The heat pipe 203 may be formed in a cylindrical shape and may be provided as a single cylinder. This heat pipe 203 may be disposed at the center of the shaft. At this time, the heat pipe 203 may not contact an area of the rotor 202 other than the shaft 2021.

In addition, the heat pipe 203 may include an insertion portion (not shown) and a protrusion 2032.

Specifically, the insertion portion may be inserted into the shaft 2021 and directly contact the shaft 2021. This insertion portion may absorb the heat generated in the shaft 2021.

The protrusion 2032 may extend from the insertion portion and protrude out of the shaft 2021. That is, the protrusion 2032 is a portion that does not contact the shaft 2021 and contacts the outside of the rotor 202. This protrusion 2032 may dissipate the heat from the heat pipe 203 to the outside. That is, the protrusion 2032 may transfer the heat from the shaft 2021, absorbed by the insertion portion, to the outside.

The heat pipe 203 including the insertion portion and the protrusion 2032 described above may cause heat exchange between the rotor 202 or the shaft 2021 and the outside, thereby improving the cooling efficiency of the motor 20 according to the second embodiment.

Further, referring to FIG. 3, the heat pipe 203 may include an accommodating portion 2033 therein.

The accommodating portion 2033 may form an empty space therein in the longitudinal direction of the heat pipe 203 throughout the insertion portion and the protrusion 2032. This accommodating portion 2033 may accommodate a cooling fluid O.

The cooling fluid O may be provided as oil, for example. The cooling fluid O may cause heat transfer between the insertion portion inserted into the shaft 2021 and the protrusion 2032 protruding to the outside while circulating through the accommodating portion 2033. At this time, the heat pipe 203 may be formed of a porous material such that the evaporated cooling fluid O may move into the empty space.

Specifically, the accommodating portion 2033 may be formed in a tapered shape whose diameter increases as it extends from the insertion portion to the protrusion 2032.

Accordingly, the cooling fluid O may circulate in the longitudinal direction of the shaft 2021 when the rotor 202 or the shaft 2021 rotates.

Specifically, an evaporator or a condenser may be provided around the motor 20 to cool the motor 20. Referring to FIG. 3(a), an evaporator may be positioned around an area A1 where the insertion portion of the heat pipe 203 is positioned. In addition, a condenser may be positioned around an area A3 where the protrusion of the heat pipe 203 is positioned. Further, an area A2 extending from the insertion portion to the protrusion 2033 of the heat pipe 203 may be an insulation section.

As the motor 20 rotates, the cooling fluid O may be biased to be close to the outside of the accommodating portion 2033, that is, the outer surface of the heat pipe 203, due to the centrifugal force. At this time, as described above, the accommodating portion 2033 positioned inside the insertion portion of the heat pipe 203 has a smaller diameter than the accommodating portion 2033 positioned inside the protrusion 2032. Therefore, as shown in FIG. 3(a), the cooling fluid O may absorb the heat from the shaft 2021 in an end portion of the insertion portion, that is, A1. The cooling fluid O starts to evaporate when it absorbs heat of a predetermined level or higher. The vapor of the evaporated cooling fluid O may move in the accommodating portion 2033, that is, the section A2, in the longitudinal direction of the heat pipe 203 toward the protrusion 2032. The vapor of the cooling fluid O having reached the protrusion 2032, that is, A3, is condensed while dissipating the heat through the protrusion 2032.

Referring to FIG. 3(b), the cooling fluid O condensed in A3 may move to A1 due to the tapered shape of the accommodating portion 2033 and the centrifugal force.

As described above, when the motor 20 operates, the cooling fluid O may cause heat transfer between the insertion portion and the protrusion 2032 to dissipate the heat from the shaft 2021 to the outside, while circulating in the longitudinal direction of the heat pipe 203 in the accommodating portion 2033.

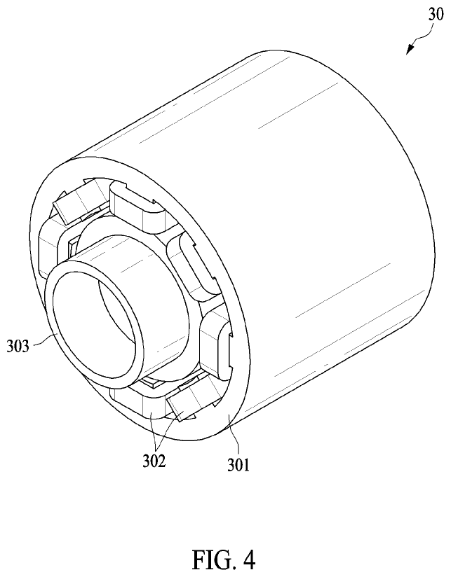

FIG. 4 is a perspective view of a motor 30 according to a third embodiment.

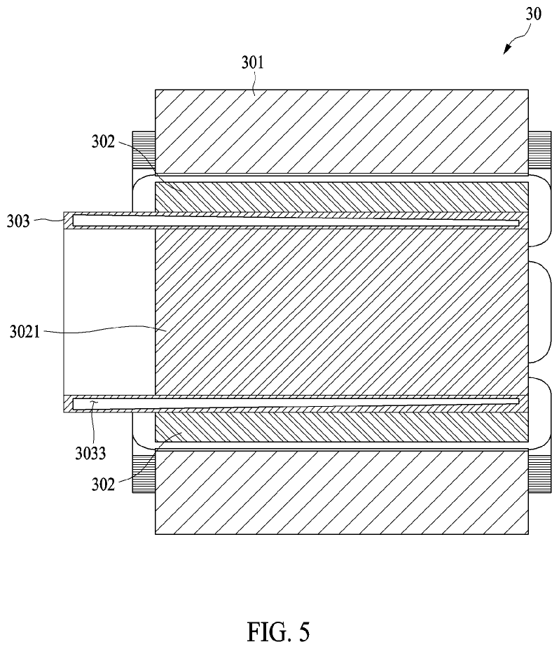

FIG. 5 is a cross-sectional view of the motor 30 according to the third embodiment.

Referring to FIG. 4, the motor 30 according to the third embodiment may include a stator 301, a rotor 302, and a heat pipe 303.

Specifically, the stator 301 may have a coil wound therein and form a magnetic field by a current flowing through the coil.

The rotor 302 may be surrounded by the stator 301 and rotated by the magnetic field generated in the coil of the stator 301.

The rotor 302 may include a shaft 3021. The shaft 3021 may be disposed at the center of the rotor 302 and may be a rotation axis of the rotor 302.

The heat pipe 303 may be inserted into the rotor 302.

The heat pipe 303 may be formed to protrude at one end thereof out of the rotor 302. Heat exchange may occur between the rotor 302 and the outside through the one end of the heat pipe 303. Accordingly, the rotor 302 may be cooled.

The heat pipe 303 may be provided as a hollow cylinder. That is, the heat pipe 303 of the motor 30 according to the third embodiment may be formed in a donut shape. This heat pipe 303 may be inserted into the rotor 302 to surround the outer surface of the shaft 3021. That is, the heat pipe 303 may be disposed between a portion of the rotor 302 and the shaft 3021.

In addition, the heat pipe 303 may include an insertion portion and a protrusion 3032.

Specifically, the insertion portion may be inserted into the rotor 302 and directly contact the outer surface of the shaft 3021. This insertion portion may absorb the heat generated in the rotor 302.

The protrusion 3032 may extend from the insertion portion and protrude out of the rotor 302. That is, the protrusion 3032 is a portion that does not contact the rotor 302 and contacts the outside of the rotor 302. This protrusion 3032 may dissipate the heat from the heat pipe 303 to the outside. That is, the protrusion 3032 may transfer the heat from the rotor 302, absorbed by the insertion portion, to the outside.

The heat pipe 303 including the insertion portion and the protrusion 3032 described above may cause heat exchange between the rotor 302 or the shaft 3021 and the outside, thereby improving the cooling efficiency of the motor 30 according to the third embodiment.

Further, referring to FIG. 5, the heat pipe 303 may include an accommodating portion 3033 therein.

The accommodating portion 3033 may form an empty space between the outer surface and the inner surface of the heat pipe 303 throughout the insertion portion and the protrusion 3032. This accommodating portion 3033 may accommodate a cooling fluid O.

The cooling fluid O may be provided as oil, for example. The cooling fluid O may cause heat transfer between the insertion portion inserted into the rotor 302 and the protrusion 3032 protruding to the outside while circulating through the accommodating portion 3033.

Specifically, the inner surface of the accommodating portion 3033 may be parallel to the inner surface of the insertion portion or the protrusion 3032, and the outer surface of the accommodating portion 3033 may have an inclination in a shape with a distance to the inner surface increasing as it extends from the insertion portion to the protrusion 3032.

Accordingly, the cooling fluid O may circulate in the longitudinal direction of the heat pipe 303 when the rotor 302 or the shaft 3021 rotates.

Similar to the motor 20 according to the second embodiment described above with reference to FIGS. 2 and 3, an evaporator or a condenser may also be provided around the motor 30 according to the third embodiment. For example, an evaporator may be positioned around an area where the insertion portion of the heat pipe 303 is positioned. In addition, a condenser may be positioned around an area where the protrusion of the heat pipe 303 is positioned. Further, an area extending from the insertion portion to the protrusion 3033 of the heat pipe 303 may be an insulation section.

As the motor 30 rotates, the cooling fluid O may be biased to be close to the outside of the accommodating portion 3033, that is, the outer surface of the heat pipe 303, due to the centrifugal force. At this time, as described above, the accommodating portion 3033 positioned inside the insertion portion of the heat pipe 303 has a smaller space than the accommodating portion 3033 positioned inside the protrusion 3032. Therefore, similar to the flow of the cooling fluid O in the accommodating portion 2033 according to the second embodiment, the cooling fluid O in the accommodating portion 3033 according to the third embodiment may absorb the heat from the rotor 302 or the shaft 3021 in an end portion of the insertion portion. The cooling fluid O starts to evaporate when it absorbs heat of a predetermined level or higher. The vapor of the evaporated cooling fluid O may move in the accommodating portion 3033, in the longitudinal direction of the heat pipe 303 toward the protrusion 3032. The vapor of the cooling fluid O having reached the protrusion 3032 is condensed while dissipating the heat through the protrusion 3032. The condensed cooling fluid O may move back to the end portion of the insertion portion due to the tapered shape of the accommodating portion 3033 and the centrifugal force.

As described above, when the motor 30 operates, the cooling fluid O may cause heat transfer between the insertion portion and the protrusion 3032 to dissipate the heat from the rotor 302 or the shaft 3021 to the outside, while circulating in the longitudinal direction of the heat pipe 303 in the accommodating portion 3033.

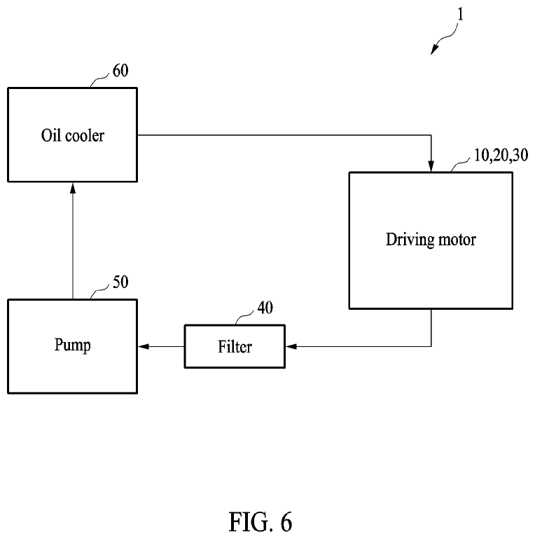

FIG. 6 is a schematic diagram of a motor cooling system 1 according to an embodiment.

Referring to FIG. 6, the motor cooling system 1 according to an embodiment may include the motor 10, 20, or 30, a filter 40, a pump 50, and a cooler 60.

Specifically, the motor 10, 20, or 30 may accommodate a cooling fluid O circulating therein.

In addition, the motor 10, 20, or 30 may include a stator, a rotor, and a heat pipe. In this case, the stator, the rotor, and the heat pipe are the same as the stators, the rotors, and the heat pipes described in relation to the first embodiment, the second embodiment, and the third embodiment.

The stator may have a coil wound therein and form a magnetic field by a current flowing through the coil.

The rotor may be surrounded by the stator and rotated by the magnetic field.

The heat pipe may be inserted into the rotor, and include therein a space for accommodating the cooling fluid O or for allowing the cooling fluid O to pass therethrough. The cooling fluid O may absorb heat generated in the rotor while passing through the heat pipe.

The filter 40 may filter the cooling fluid O having passed through the motor 10, 20, or 30.

The pump 50 may be disposed between the filter 40 and the cooler 60. This pump 50 may move the cooling fluid O from the filter 40 to the cooler 60. Further, the pump 50 may be additionally disposed between the cooler 60 and the motor 10, 20, or 30. This pump 50 may move the cooling fluid O from the cooler 60 to the motor 10, 20, or 30.

The cooler 60 may cool the cooling fluid O having absorbed the heat from the motor 10, 20, or 30. The cooling fluid O cooled by the cooler 60 may be introduced into the motor 10, 20, or 30 again to cool the motor 10, 20, or 30.

As described above, the motor 10, 20, or 30 according to the first, second, or third embodiment and the motor cooling system 1 including the same may effectively cool the heat generated in the motor 10, 20, or 30 through a heat pipe having high thermal conductivity, installed in the rotor of the motor 10, 20, or 30. In addition, the motor 10, 20, or 30 according to the first, second, or third embodiment and the motor cooling system 1 including the same may ultimately prevent degradation of the performance of the motor through the heat pipe described above.

While the embodiments of the present disclosure have been described above with reference to specific components, and limited embodiments and drawings, the above descriptions are merely for better understanding of the present disclosure, and it will be apparent to one of ordinary skill in the art that various changes in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. Accordingly, the scope of the present disclosure is defined not by the detailed description, but by the claims and their equivalents, and all variations within the scope of the claims and their equivalents are to be construed as being included in the disclosure.

1. A motor comprising:
a stator in which a coil is wound and which forms a magnetic field by a current flowing through the coil;
a rotor which is surrounded by the stator and is rotated by the magnetic field; and
a heat pipe which is inserted into the rotor,
wherein the heat pipe is formed to protrude at one end thereof out of the rotor, and cools the rotor by causing heat exchange between the rotor and the outside through the one end.

2. The motor of claim 1, wherein the heat pipe comprises:
an insertion portion which contacts the inside of the rotor; and
a protrusion which extends from the insertion portion and protrudes out of the rotor,
wherein the insertion portion absorbs heat generated in the rotor, and the protrusion transfers the heat absorbed by the insertion portion to the outside to cool the rotor.

3. The motor of claim 1, wherein
the heat pipe comprises an accommodating portion which forms a space for accommodating a cooling fluid therein, and
the cooling fluid causes heat transfer between a portion of the heat pipe inserted into the rotor and the one end of the heat pipe protruding to the outside while moving in the accommodating portion.

4. The motor of claim 3, wherein
the accommodating portion has a tapered shape whose diameter increases as it extends from the rotor to the outside, and
the cooling fluid is capable of circulating in a longitudinal direction of the rotor when the rotor rotates.

5. The motor of claim 4, wherein
the rotor comprises a shaft rotatably disposed at a center thereof, and
the heat pipe is provided as a single cylinder and inserted into a center of the shaft.

6. The motor of claim 1, wherein
the rotor comprises a shaft rotatably disposed at a center thereof, and
the heat pipe is provided as a hollow cylinder and inserted into the rotor in a form surrounding an outer surface of the shaft.

7. The motor of claim 1, wherein
the heat pipe is provided as a plurality of cylinders, and the heat pipes are spaced apart from each other in a circumferential direction of the rotor.

8. A motor cooling system comprising:
a motor in which a cooling fluid circulating therethrough is accommodated;
a filter which filters the cooling fluid having passed through the motor; and
a cooler which cools the cooling fluid having absorbed heat from the motor,
wherein the cooling fluid cooled by the cooler is introduced into the motor again to cool the motor.

9. The motor cooling system of claim 8, wherein the motor comprises:
a stator in which a coil is wound and which forms a magnetic field by a current flowing through the coil;
a rotor which is surrounded by the stator and is rotated by the magnetic field; and
a heat pipe which is inserted into the rotor,
wherein the cooling fluid absorbs heat generated in the rotor while passing through the heat pipe.

10. The motor cooling system of claim 8, further comprising:
a pump which moves the cooling fluid from the filter to the cooler or from the cooler to the motor.
